(19) United States
(12) Patent Application Publication
(10) Pub. No.: US 2009/0058786 A1
(43) Pub. Date: Mar. 5, 2009

(54) Liquid crystal display and inversion drive method

(76) Inventor: Tzong-Yau Ku, Tainan (TW)

Correspondence Address: TROP, PRUNER & HU, P.C., 1616 S. VOSS ROAD, SUITE 750, HOUSTON, TX, 77057-2631, US

(21) Appl. No.: 12/231,492

(22) Filed: Sep. 2, 2008

(30) Foreign Application Priority Data
Sep. 4, 2007 (TW) 96132892

(51) Int. Cl. G09G 3/36

(52) U.S. Cl. 345/96

(57) ABSTRACT

One embodiment of the invention includes an liquid crystal display (LCD) with multiple polarity signal lines that control output buffer blocks so that at least one voltage polarity of a signal transmitted via a data line controlled by a first output buffer block inverts non-simultaneously with at least one voltage polarity of a signal transmitted via a data line controlled by a second output buffer block.

### CROSS-REFERENCE TO RELATED APPLICATION

Pursuant to 35 U.S.C. §119, this application claims priority to Taiwan Application Serial No. 96132892, filed Sep. 4, 2007, the subject matter of which is incorporated herein by reference.

### BACKGROUND

A liquid crystal display (LCD) typically includes a liquid crystal layer that further includes liquid crystal molecules whose orientations can be controlled by application of electric fields. If liquid crystal molecules in an LCD remain fixed at a certain voltage for too long a period of time, the liquid crystal molecules may no longer react to electric field variations (which would typically rotate the liquid crystal molecules to control brightness). This may result in image sticking. Therefore, some LCD designs apply alternating current levels to the liquid crystal molecules to address such issues.

The display voltage in an LCD may be divided into two polarities: positive and negative. A positive polarity exists when the display voltage of a pixel electrode is higher than that of a common electrode. A negative polarity exists when the display voltage of a pixel electrode is lower than that of the common electrode. Regardless of the positive or negative polarity, the resultant gray level has the same brightness. Periodically inverting the display voltage between positive and negative polarities maintains the display frame while avoiding the aforementioned damage of liquid crystal molecule properties.

LCD panels may invert the driving voltage polarity when replacing frame data. For example, with a refresh rate of 60 Hz the polarity of a frame is inverted every 16 ms. In other words, the polarity of the same dot on an LCD panel is continuously inverted at periodic intervals. Whether adjacent dots have the same polarity is based on which of the different polarity inversion techniques is used. For the frame inversion technique shown in FIG. 1(a), all dots 10 in the frame have the same polarity. For the row inversion technique shown in FIG. 1(b), every row of dots has a polarity different from the adjacent rows of dots. For the column inversion technique shown in FIG. 1(c), every column has a different polarity from its adjacent columns. For the dot inversion technique shown in FIG. 1(d), every dot has a polarity opposite its adjacent dots. For the two-line inversion technique shown in FIG. 1(e), every two adjacent dots in the same data line (i.e., column) are viewed as a single unit (14) and have the same polarity while their surrounding dots have opposite polarities. For the four-line inversion technique shown in FIG. 1(f), every four adjacent dots in the same data line are viewed as a single unit (141) and have the same polarities while their surrounding adjacent dots have opposite polarities.

When a current frame is driven according to any one of the above polarity inversion techniques, the polarity of the next frame is typically inverted. Polarity inversion is usually controlled by a polarity signal line. FIG. 2 shows a conventional architecture of a data driver which drives data lines (i.e., columns), in which a polarity signal line 15 receives polarity control signals from a controller (e.g., timing controller) and sends the control signals to buffer blocks 16, 17. Buffer block 16 may include a buffer 18 composed of p-type transistors and a buffer 19 composed of n-type transistors. Based on the above polarity control signals, two output terminals 181 and 191 are driven to output a positive polarity voltage and a negative polarity voltage, respectively. When the buffer 18 composed of p-type transistors drives the output terminal 181 to output a positive polarity voltage, the output terminal 191 is driven by the buffer 19 composed of n-type transistor to output a negative polarity voltage, and vice versa. The buffer block 17 is similarly configured as buffer block 16 and provides output to terminals 182, 192.

The polarity signal line 15 can determine whether the output voltage of each output terminal 181, 191, 182, or 192 is of positive polarity or negative polarity. For example, when the polarity signal line 15 sends a polarity control signal of positive polarity, the output terminals 181 and 182 are of positive polarity, while the output terminals 191 and 192 are of negative polarity. Also, when the polarity signal line 15 sends a polarity control signal of negative polarity, the output terminals 181 and 182 are of negative polarity, while the output terminals 191 and 192 are of positive polarity.

In addition to image information of a frame, a general data driver needs an external power source to provide a working power or a reference voltage (e.g., a ground voltage V_{GND}) required for its internal circuits. Attenuation generated by routing impedance between the external power source and the data driver may affect the reference voltage received by the data driver. Because power consumption during polarity inversion is at its maximum level, the above prior art (where polarity signal lines drive data lines in a serial manner) can cause large peak currents, which can result in a problem in devices that utilize, for example, wire on array (WOA) technology. This problem may arise because some data drivers may receive related image information, power, and the reference signal via other data drivers and the wiring length between the external power source and the signal source may be long. When the current is instantaneously raised, the load of the external circuit may also increase immediately. Moreover, the impedance of glass may be higher. Therefore, the ground reference voltage received by the data driver may be greatly affected as a result. More specifically, FIG. 3 shows a waveform of the ground reference voltage received by a data driver. The reference voltage can change from a normal 0.2 V to an abnormal 1.7 V during data line polarity changes. Such a large voltage variation or spike may result in abnormal operation of the data driver, which can affect the display provided by an LCD panel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In order to make the above and other objects, features and advantages of the present invention more comprehensible, several embodiments accompanied with figures are described in detail below.

FIGS. 1(a) to 1(f) show prior art techniques including a frame inversion technique, row inversion technique, column inversion technique, dot inversion technique, two-line inversion technique, and four-line inversion technique, respectively;

FIG. 2 is a schematic diagram of conventional buffer blocks configured in series;

FIG. 3 is a graph of a ground reference voltage received by a data driver when the polarity signal line performs a conventional two-line inversion technique;

FIG. 4 is a schematic diagram of a driving device according to one embodiment of the invention;

FIG. 5(a) is a schematic representation of transmitted voltage signals received by a data driver when two polarity signal lines perform two-line inversion technique;

FIG. 5(b) is a graph of ground voltage received by a data driver when two polarity signal lines perform two-line inversion technique; and

FIG. 6 is a schematic representation of transmitted voltage signals received by a data driver when four polarity signal lines perform four-line inversion technique.

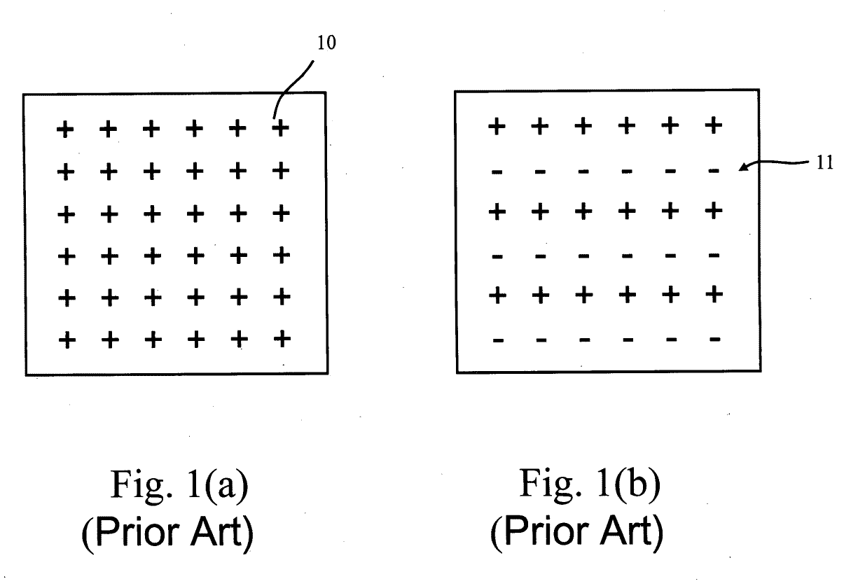

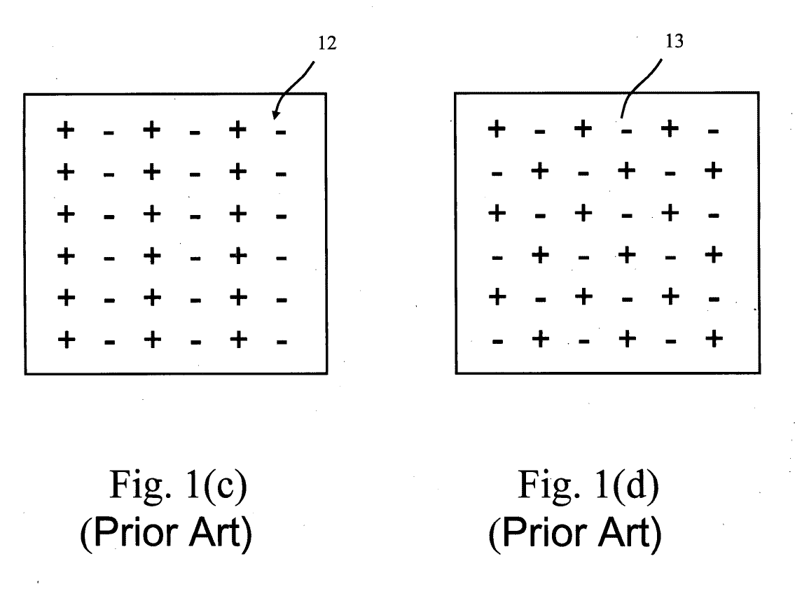

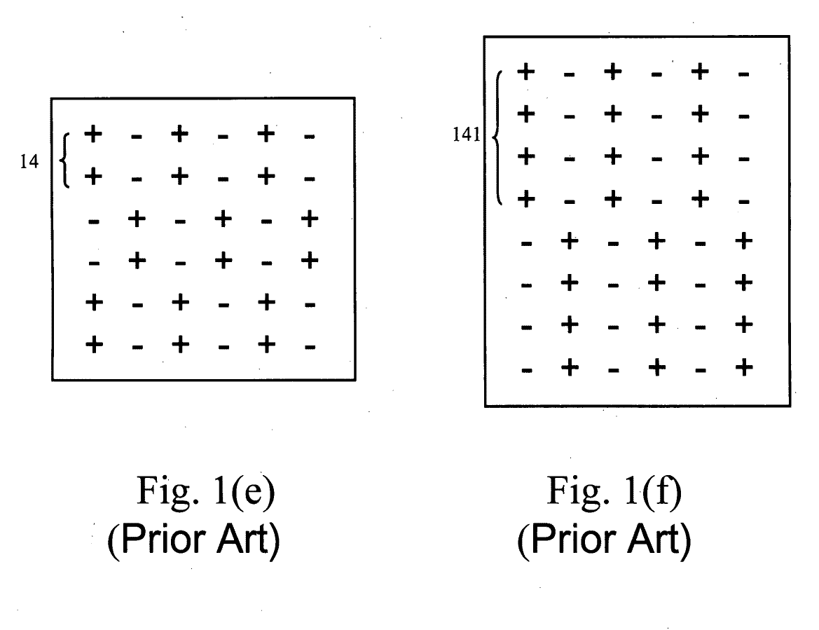

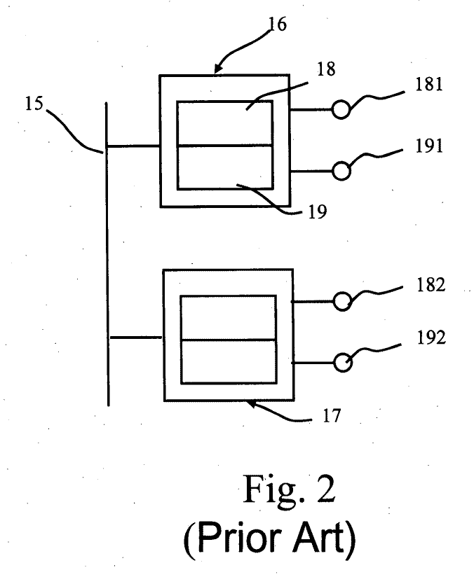

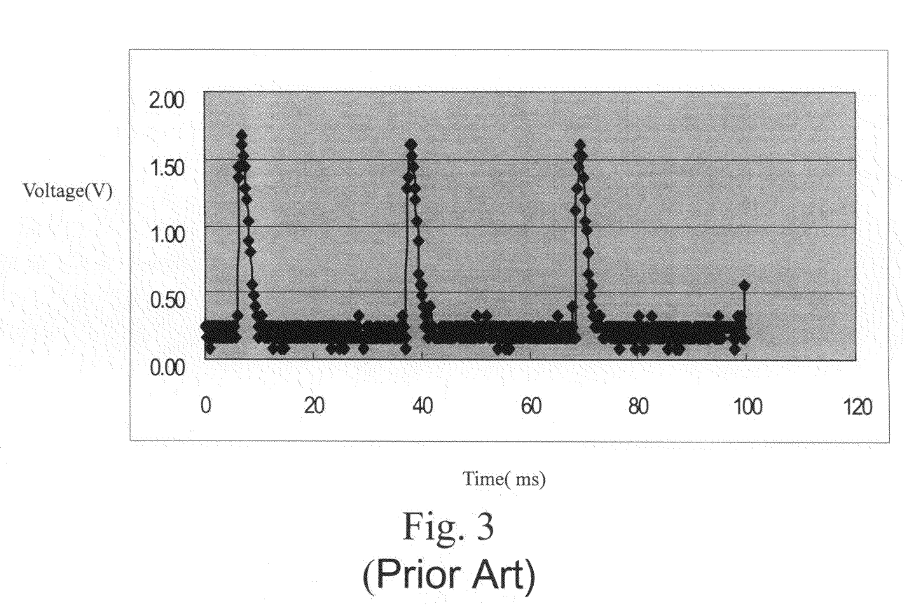

### DETAILED DESCRIPTION

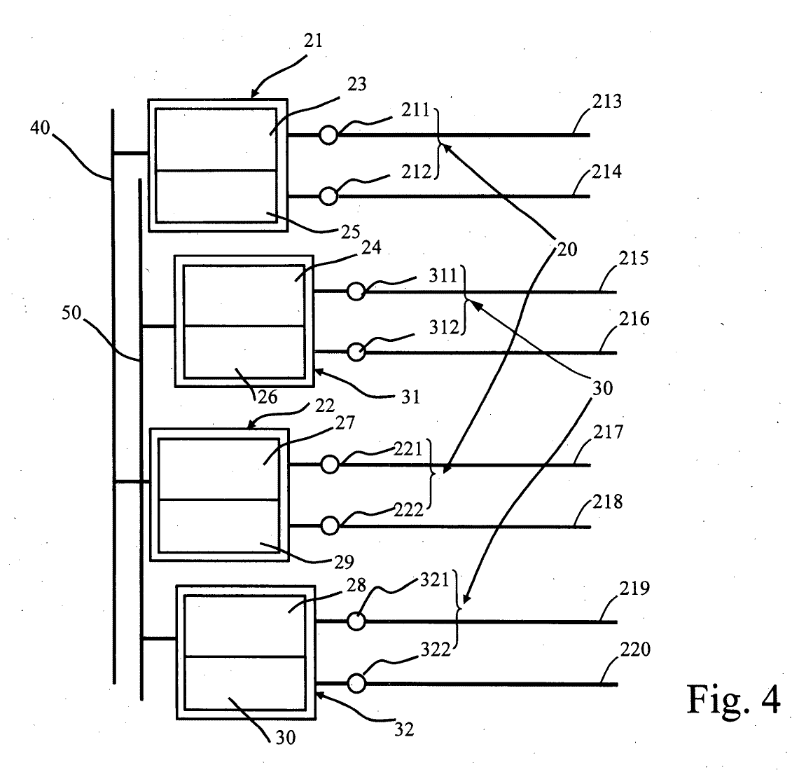

As shown in FIG. 4, an embodiment of the invention includes a driving device with polarity inversion of data line signals for an liquid crystal display (LCD) panel. The driving device can drive polarity inversion of liquid crystal molecules in an LCD panel. The driving device may include two output drive block groups 20 and 30 in a data driver coupled to two polarity signal lines 40 and 50. The two output buffer block groups 20 and 30 may include output buffer blocks 21, 22 and 31, 32, respectively.

The output buffer blocks 21 and 31 may include buffers 23, 24 composed of p-type transistors and buffers 25, 26 composed of n-type transistors. Output buffer blocks 21 and 31 can respectively drive output terminals 211, 212 and 311, 312 to output a positive polarity voltage or a negative polarity voltage. In one embodiment of the invention, each terminal is coupled to a data line. Thus, the output buffer block 21 may control polarity of the voltages of the output terminal 211 and data line 213 and output terminal 212 and data line 214, and the output buffer block 31 may control polarity of the voltages of the output terminal 311 and data line 215 and output terminal 312 and data line 216.

Similarly, the output buffer blocks 22 and 32 may include buffers 27, 28 composed of p-type transistors and buffers 29, 30 composed of n-type transistors. Output buffer blocks 22 and 32 can respectively drive output terminals 221, 222 and 321, 322 to output a positive polarity voltage or a negative polarity voltage. In one embodiment of the invention, each terminal is coupled to a data line. Thus, the output buffer block 22 may control polarity of the voltages of the output terminal 221 and data line 217 and output terminal 222 and data line 218, and the output buffer block 32 may control polarity of the voltages of the output terminal 321 and data line 219 and output terminal 322 and data line 220.

Two polarity signal lines 40 and 50 may receive polarity control signals from external control circuits (e.g., timing controllers), and are respectively connected to the two output buffer block groups 20 and 30. Polarity signal lines 40 and 50 can be used to control the two output buffer block groups 20 and 30 to respectively output a voltage so as to determine whether the voltage of each output terminal and each associated data line is of positive polarity or negative polarity. For example, when the polarity signal line 40 is of positive polarity, the output buffer blocks 21 and 22 in the first output buffer block group 20 will control the output terminals 211 and 221 and associated data lines 213, 217 to be of positive polarity and the output terminals 212 and 222 and associated data lines 214, 218 to be of negative polarity. When the polarity signal line 40 is of negative polarity, the output terminals 211 and 221 and associated data lines 213, 217 will be of negative polarity, while the output terminals 212 and 222 and associated data lines 214, 218 will be of positive polarity. Similarly, when the polarity signal line 50 is of positive polarity, the output buffer blocks 31 and 32 in the second output buffer block group 30 will control the output terminals 311 and 321 and associated data lines 215, 219 to be of positive polarity and the output terminals 312 and 322 and associated data lines 216, 220 to be of negative polarity. When the polarity signal line 50 is of negative polarity, the output terminals 311 and 321 and associated data lines 215, 219 will be of negative polarity, while the output terminals 312 and 322 and associated data lines 216, 220 will be of positive polarity.

Moreover, the two polarity signal lines control the output terminals, and data lines coupled thereto, to perform polarity inversion at different time points. That is, at a first time point for polarity inversion (i.e., time when polarity change actually occurs or flips), the polarity control signal transmitted by the polarity signal line 40 changes so that the polarity signal line 40 controls the output terminals of the first output buffer block group 20 to invert the polarity of the output voltage. Next, at a second time point, the polarity control signal transmitted by the polarity signal line 50 changes so that the polarity signal line 50 controls the output terminals of the second output buffer block group 30 to invert the polarity of the output voltage. Thus, the actual polarity changes for polarity signal lines 40, 50 are staggered. Because the above output terminals 211, 212, 221, 222, 311, 312, 321, 333 respectively transmit signals to data lines 213, 214, 217, 218, 215, 216, 219, 220 on an LCD panel, the time points for signal polarity inversion of data lines that receive signals from the output terminals of the first output buffer block group 20 will be different from the time points for signal polarity inversion of data lines that receive signals from the output terminals of the second output buffer block group 30.

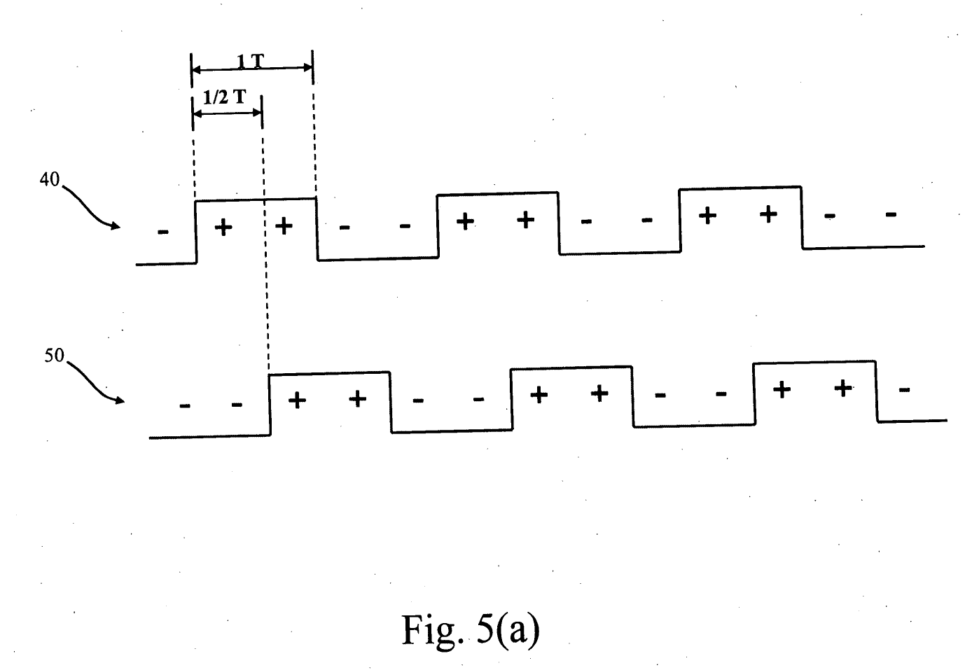

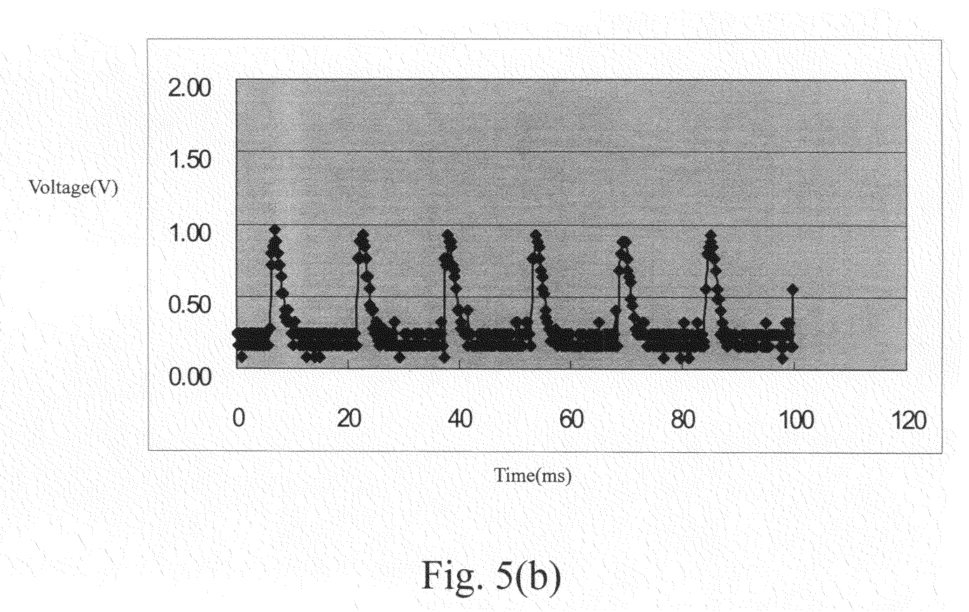

As shown in FIG. 5(a), in one embodiment of in the invention the signals on the polarity signal line 40 and the polarity signal line 50 have a phase offset of ½ T (where T is the time required for data refresh of one column of pixels on an LCD panel). The exemplary signals depicted in FIG. 5(a) are used for applying the two-line inversion technique. Thus, the transmission times for actual polarity inversion changes are staggered so that signal 40 does not invert or transition at the exact same time as signal 50. However, there are interlaced periods of overlap where signals 40 and 50 have the same polarity and periods where they have different polarities. In one implementation, at each time point only half of the output terminals perform polarity inversion.

As shown in FIG. 5(b), the reference voltage (e.g., ground reference voltage) received by the data driver will be affected most during polarity inversion, but is hardly affected when there is no polarity inversion. In an embodiment of the invention, as depicted according to FIG. 5(a), polarity inversion can be carried out for one half of the time while the polarities are maintained for another half of time, thereby lowering the amplitude of the reference voltage waveform spike to one half the amplitude experienced in the prior art. Therefore, the peak currents (i.e., reference voltage spikes) can be substantially reduced as compared to those in the prior art, thereby enhancing the characteristics of the LCD panel.

In one embodiment of the invention, the phase offset of polarity inversion of multiple polarity signal lines can be, for example, ⅛ T, ¼ T, ⅓ T or ½ T. There can be two or more polarity signal lines so that dot inversion, two-line inversion, four-line inversion, and other inversion techniques can be performed to control the voltages of the output terminals.

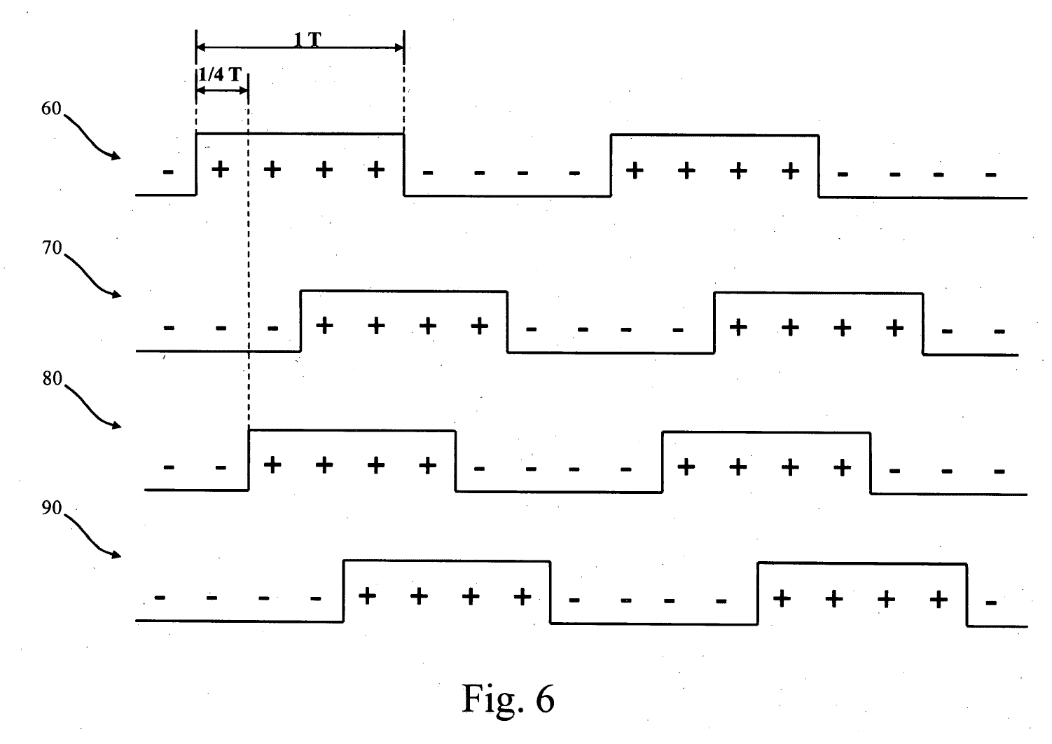

As shown in FIG. 6, for example, four polarity signal lines 60, 70, 80 and 90 are used to achieve four-line inversion in one embodiment of the invention. These four polarity signal lines 60, 70, 80 and 90 may drive polarity inversion of output buffer blocks at a phase offset ¼ T. Polarities of the voltages of only one fourth of the output terminals are inverted at every time point, thereby lowering the amplitude of peak currents.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a first output buffer block including a first buffer to control a first output voltage to a first data line in a liquid crystal display (LCD) and a second buffer to control a second output voltage to a second data line in the LCD;
a second output buffer block including a third buffer to control a third output voltage to a third data line in the LCD and a fourth buffer to control a fourth output voltage to a fourth data line in the LCD; and
a first polarity signal line to invert a polarity of the first output voltage at a first time point and a second polarity signal line to invert a polarity of the third output voltage at a second time point not coinciding with the first time point.

2. The apparatus of claim 1, wherein the first buffer includes p-type transistors to drive the polarity of the first output voltage to a positive polarity when the first polarity signal line conducts a positive signal.

3. The apparatus of claim 2, wherein the second buffer includes n-type transistors to drive a polarity of the second output voltage to a negative polarity when the first polarity signal line conducts a positive signal.

4. The apparatus of claim 1, wherein the first output voltage is positive and the second output voltage is negative when the first polarity signal line conducts a positive signal, and the first output voltage is negative and the second output voltage is positive when the first polarity signal line conducts a negative signal.

5. The apparatus of claim 4, wherein the third output voltage is positive and the fourth output voltage is negative when the second polarity signal line conducts a positive signal, and the third output voltage is negative and the fourth output voltage is positive when the second polarity signal line conducts a negative signal.

6. The apparatus of claim 1, wherein the first time point is to be separated from the second time point by less than a time period required to refresh the first data line.

7. The apparatus of claim 1, wherein the first polarity signal line is to invert a polarity of the second output voltage at the first time point and the second polarity signal line is to invert a polarity of the fourth output voltage at the second time point.

8. The apparatus of claim 1, further comprising:
a third output buffer block including a fifth buffer to control a fifth output voltage to a fifth data line in the LCD and a sixth buffer to control a sixth output voltage to a sixth data line in the LCD;
a fourth output buffer block including a seventh buffer to control a seventh output voltage to a seventh data line in the LCD and an eighth buffer to control an eighth output voltage to an eighth data line in the LCD; and
the first polarity signal line to invert a polarity of the fifth output voltage at the first time point and the second polarity signal line to invert a polarity of the seventh output voltage at the second time point.

9. A method comprising:
using a first polarity signal line, coupled to a first output buffer block that includes a first buffer, to invert a first output voltage to a first data line in a liquid crystal display (LCD) at a first time point; and
using a second polarity signal line, coupled to a second output buffer block that includes a second buffer, to invert a second output voltage to a second data line in the LCD at a second time point not coinciding with the first time point.

10. The method of claim 9, comprising:
using the first polarity signal line, coupled to the first output buffer block that includes a third buffer, to invert a third output voltage to a third data line in the LCD at the first time point; and
using the second polarity signal line, coupled to the second output buffer block that includes a fourth buffer, to invert a fourth output voltage to a fourth data line in the LCD at the second time point.

11. The method of claim 10, comprising:
using the first polarity signal line, coupled to a third output buffer block that includes a fifth buffer, to invert a fifth output voltage to a fifth data line in the LCD at the first time point; and
using the second polarity signal line, coupled to a fourth output buffer block that includes a sixth buffer, to invert a sixth output voltage to a sixth data line in the LCD at the second time point.

12. The method of claim 9, comprising:
using the first polarity signal line to invert the first output voltage to a first polarity at the first time point; and
using the second polarity signal line to invert the second output voltage to a second polarity at the second time point.

13. The method of claim 12, comprising:
conducting a signal of the first polarity on the first polarity signal line to invert the first output voltage to the first polarity at the first time point; and
conducting a signal of the second polarity on the second polarity signal line to invert the second output voltage to a second polarity at the second time point.

14. The method of claim 9, comprising:
using the first polarity signal line to invert the first output voltage to a first polarity at the first time point; and
using the second polarity signal line to invert the second output voltage to the first polarity at the second time point.

15. The method of claim 9, further comprising inverting the second output voltage at the second time point which follows the first time point by less than a time period required to refresh the first data line.

16. An liquid crystal display (LCD) comprising:
a first output buffer block group and a second output buffer block group to control voltage polarity of signals transmitted via data lines included in a liquid crystal display (LCD) panel; and
two polarity signal lines to respectively control the first and second output buffer block groups such that at least one voltage polarity of a signal transmitted via a data line controlled by the first output buffer block group inverts non-simultaneously with at least one voltage polarity of a signal transmitted via a data line controlled by the second output buffer block group.

17. The LCD of claim 16, wherein each of the output buffer block groups includes a first buffer block that further includes a first buffer to control a voltage polarity of a signal transmitted via a first output terminal and a second buffer to control a voltage polarity of a signal transmitted via a second output terminal.

18. The LCD of claim 17, wherein the first buffer includes p-type transistors to drive the signal transmitted via the first output terminal to a positive polarity.

19. The LCD of claim 17, wherein the second buffer includes n-type transistors to drive the signal transmitted via the second output terminal to a negative polarity.

20. The LCD of claim 16, wherein the time difference for polarity inversion of the two polarity signal lines is, 1/n T, where T is a time period required to refresh the first data line and n is greater than 1.
